(19) United States
(12) Patent Application Publication
(10) Pub. No.: US 2024/0291952 A1
(43) Pub. Date: Aug. 29, 2024

(54) CALIBRATION METHOD

(71) Applicant: ams-OSRAM Asia Pacific Pte. Ltd., Singapore (SG)

(72) Inventor: Yann LEPOITTEVIN, Lausanne (CH)

(21) Appl. No.: 18/569,241

(22) PCT Filed: Mar. 23, 2022
(86) PCT No.: PCT/SG2022/050155

§ 371 Date: Dec. 12, 2023

(30) Foreign Application Priority Data
Jul. 2, 2021 (GB) 2109575.7

(51) Int. Cl. H04N 9/31; G03B 17/54

(52) U.S. Cl. CPC H04N 9/3194; G03B 17/54; H04N 9/3185

(57) ABSTRACT

A method of calibrating a structured light imaging device includes an image sensor and a structured light projector. The method includes projecting, by the structured light projector, a pattern of structured light onto a target, the target including a plurality of optical markers, capturing, by the image sensor, an image of the pattern on the target, determining, using (i) predetermined data specifying properties of the optical markers and (ii) the appearance of the markers in the captured image, a pose of the device relative to the target, and rendering an image of the target and the pattern using the pose of the device and initial calibration data using a 3D model of the observed calibration scene. The method then includes iteratively refining said rendered image until a substantial convergence is achieved between the rendered image and the captured image by adjusting the calibration data.

### RELATED APPLICATION(S)

This application is a US National Stage Application of International Application PCT/SG2022/050155, filed on 23 Mar. 2022, and claims priority under 35 U.S.C. § 119(a) and 35 U.S.C. § 365(b) from United Kingdom Application GB 2109575.7, filed on 2 Jul. 2021, the contents of which are incorporated herein by reference in their entirety.

### FIELD

The present disclosure relates to a method of calibrating a structured light imaging device and, more precisely, to a method of calibrating a structured light imaging device using a differentiable renderer.

### BACKGROUND

Structured light is light having a specific pattern (i.e. light which is spatially coded or modulated). Structured light can be exploited to obtain depth and surface information of objects in a scene of interest, for example during three-dimensional (3D) sensing, with applications in diverse fields such as autonomous vehicles, augmented reality, virtual reality, gaming, and face recognition.

Structured light imaging devices include a light projector and an image sensor. The projector emits a pattern of structured light onto a scene, and surface features of objects within the scene cause the reflected pattern to appear distorted. The image sensor captures an image of the scene, and the observed reflected pattern is compared to the undistorted projected pattern. The differences between the two patterns are then used to determine depth and surface information of the observed objects.

As with many digital imaging devices, it is necessary to calibrate the structured light imaging devices prior to use in order to compensate for aberrations inherent to the components of the devices. Calibration of structured light imaging devices is more challenging than traditional camera calibration due to the additional information arising from the structured light projectors. Known methods of calibrating structured light imaging devices therefore often require the capture of multiple images. Calibration with only one image is challenging and often several images are necessary. Furthermore, as the process is noisy, having more images allows for a stable solution.

### SUMMARY

The present disclosure provides an improved method of calibrating a structured light imaging device, which requires fewer images than previous approaches.

According to a first aspect of the present disclosure there is provided a method of calibrating a structured light imaging device comprising an image sensor and a structured light projector. The method comprises:
(a) projecting, by the structured light projector, a pattern of structured light onto a target, the target comprising a plurality of optical markers;
(b) capturing, by the image sensor, at least an image of the pattern on the target;
(c) determining, using (i) predetermined data specifying properties of the optical markers and (ii) an appearance of the markers in the captured image, the pose of the device relative to the target;
(d) rendering an image of the target and the pattern using the pose of the device, a 3D model of the scene and calibration data; and
(e) iteratively refining the rendered image until a substantial convergence is achieved between the rendered image and the captured image by adjusting the calibration data.

The calibration data may comprise intrinsic parameters for the image sensor and the light projector, distortion coefficients, and extrinsic parameters.

The final calibration data may be saved to a memory as a calibration data file.

Step (e) may comprise applying a gradient descent algorithm to minimize a cost function comprising the rendered and acquired images to refine the calibration data.

According to a second aspect of the present disclosure there is provided a method of using a structured light imaging device comprising an image sensor and a structured light projector. The method comprises:
capturing an image with the imaging sensor; and
correcting said image using the adjusted calibration data according to any one preceding claim.

According to a third aspect of the present disclosure there is provided a structured light imaging device comprising an image sensor and a structured light projector, and a memory storing adjusted calibration data generated using the method of the first aspect.

According to a fourth aspect of the present disclosure there is provided a method of calibrating a structured light imaging device comprising an image sensor and a structured light projector, the method comprising:
(a) projecting, by the structured light projector, a pattern of structured light onto a target, the target comprising a plurality of optical markers;
(b) capturing, by the image sensor, an image of the pattern on the target;
(c) determining, using (i) predetermined data specifying properties of the optical markers and (ii) the appearance of the markers in the captured image, an estimated pose of the target relative to the image sensor and an estimated pose of the target relative to the structured light projector;
(d) rendering a first synthetic image of the target including an expected appearance of the optical markers, using a 3D model including known properties of the optical markers, the estimated pose of the target relative to the image sensor, and estimated values of intrinsic image sensor calibration parameters;
(e) refining, by inverse rendering, the estimated pose of the target relative to the image sensor and the estimated intrinsic image sensor calibration parameters, by matching the captured image to the first synthetic image until substantial convergence is reached;
(f) rendering a second synthetic image of the target including an expected pattern of the structured light, using a 3D model including known properties of the pattern of structured light, the estimated pose of the target relative to the structured light projector, the refined pose of the target relative to the image sensor, the refined intrinsic image sensor calibration parameters, and estimated values of intrinsic projector calibration parameters; and
(g) refining, by inverse rendering, the estimated pose of the target relative to the structured light projector and the estimated intrinsic projector calibration parameters, by matching the captured image to the second synthetic rendered image until substantial convergence is reached.

### BRIEF DESCRIPTION OF THE DRAWINGS

The accompanying drawings are included to provide further understanding, and are incorporated in, and constitute a part of, the specification. As such, the disclosure will be more fully understood from the following detailed description, taken in conjunction with the accompanying figures in which:

FIG. 1 shows schematically a structured light imaging device during calibration; and

FIG. 2 and FIG. 3 are flow diagrams showing methods of calibrating a structured light imaging device.

### DETAILED DESCRIPTION

A method of calibrating a structured light imaging device will now be described with reference to the accompanying drawings.

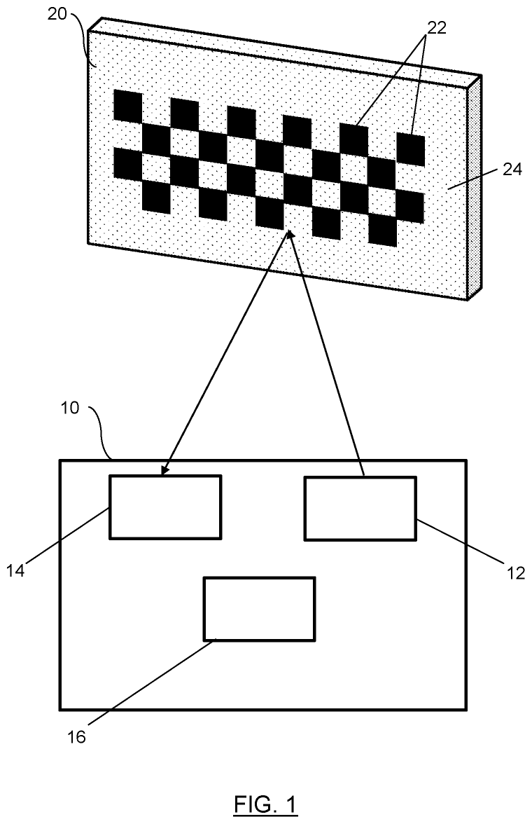

FIG. 1 shows schematically a structured light imaging device 10 during calibration with a calibration target 20. The structured light imaging device 10 comprises a structured light projector 12, an image sensor 14, and a processing unit 16 (which is shown integrated into the device 10 but which may be provided externally of the device). The calibration target 20 is a flat target comprising optical markers 22 (shown as checkerboard squares).

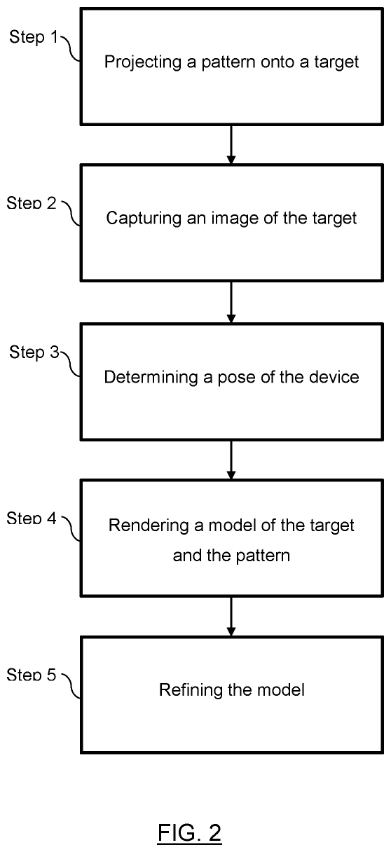

FIG. 2 is a flow diagram showing a method of calibrating a structured light imaging device such as the device shown in FIG. 1.

In Step 1, pattern data is generated and stored by the processing unit 16, for example by some simulation tool before production of the projector. The pattern 24 is projected by the structured light projector 12 onto the target 20. The pattern 24 of the structured light may be any suitable regular or irregular pattern, e.g. of lines, shapes, or dots as shown in FIG. 1.

Light is reflected by the target 20, to form an image including the optical markers 22 and the reflected projected pattern 24. The image is collected by the image sensor 14 (Step 2) and stored by the processing unit 16.

In Step 3, the processing unit 16 retrieves stored information as to the properties of the optical markers 22 on the target (i.e. size, shape, and/or position). Using the retrieved information and the appearance (size, shape, and/or position) of the markers 22 in the captured image, the processing unit 16 determines the relative position and orientation (hereinafter referred to collectively as the “pose”) of the structured illumination imaging device 10 with respect to the target. This process may rely, for example, on basic triangulation: the markers are detected in the image, whilst the distance between those markers is known and can be used to infer the position of the image sensor with respect to those markers as well as the distortion of the image captured by the image sensor.

In Step 4, the processing unit 16 uses a differentiable renderer to generate a computational model of the calibration target 20 using 3D simulation. The simulation includes the optical markers 22, the projected pattern 24 on the target surface as well as the imaging sensor and the projector. As inputs to the model, the processing unit 16 uses the pose of the target calculated in Step 3, and initial estimates of calibration parameters.

The calibration parameters may include intrinsic parameters for the projector 12 and intrinsic parameters for the image sensor 14 (such as focal length and coordinates of the optical centre, and field of view); distortion coefficients, such as radial and tangential distortion coefficients of any additional optics; and extrinsic parameters including the relative positions of the target surface, the image sensor, and the projector.

In Step 5, the calibration parameters are refined to optimize the simulated image obtained by the rendering model and the captured image. This is performed by applying any known gradient descent algorithm to minimize a cost function comprising the initial calibration data. Step 5 is repeated until a predetermined convergence is reached, and the final calibration data is obtained, which is then stored by the processing unit 16, for example in an associated or integrated memory. Alternatively, a fixed, predefined, number of iterations may be applied.

Exemplary data established within a calibration file may include:
camera intrinsics:
   resolution (width, height)
   focal (row, column)
   principal point (row, column)
   distortion (model, radial coefficients, tangential coefficients)
   field of view (row, column)
projector intrinsics:
   resolution (width, height)
   focal (row, column)
   principal point (row, column)
   distortion (model, radial coefficients, tangential coefficients)
   field of view (row, column)
extrinsics:
   rotation, translation

By using a differentiable renderer to simulate an image of the target 20, considering the target 20, the image sensor 14, and the structured light projector 12, the above method allows for the effective calibration of a structured illumination imaging device 10 using only a few captured images. This contrasts with known methods which can typically only use detected points in the image to compute the triangulation. Those points are sparse, and their detected position is often impacted by noise. The present method can leverage each pixel of the image to compute the triangulation. This reduces the time needed by an operator to collect multiple images and instead uses computing time to perform the calibration. The method allows for a similar quality of calibration with less images or better quality of calibration with a similar number of images.

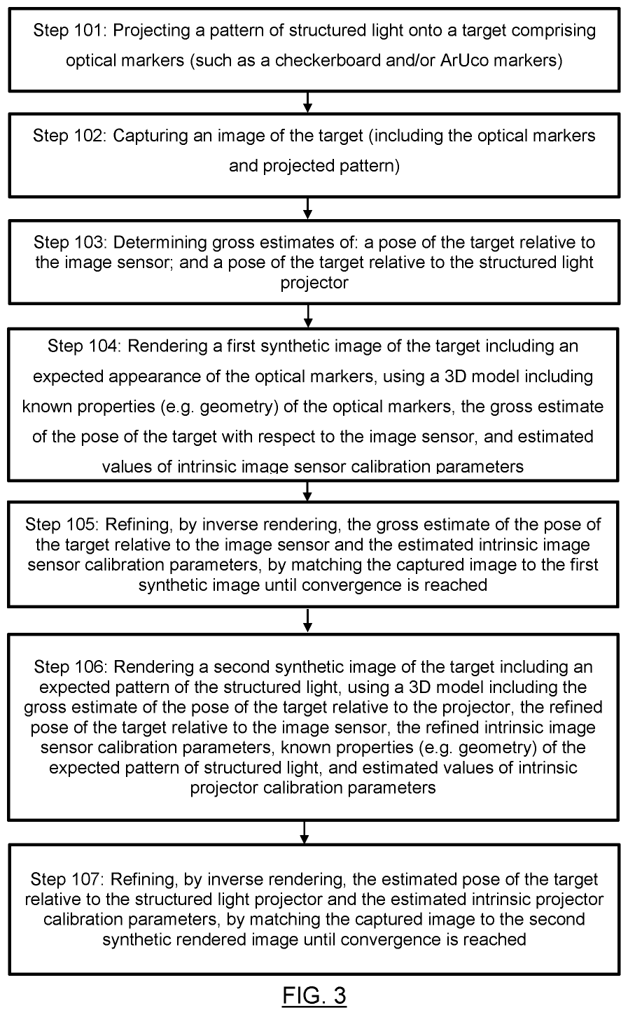

FIG. 3 is a flow diagram showing a method of calibrating a structured light imaging device such as the device shown in FIG. 1.

In Steps 101 to 102, a pattern of structured light is projected onto the target and an image of the target is captured (for example as described above in relation to Steps 1 to 2 of FIG. 2).

In Step 103, the pose of the target is estimated relative to the image sensor and the structured light projector. In one example, an estimated pose of the target with respect to the image sensor may be determined directly, and an estimated pose of the target with respect to the projector may then be determined indirectly according to the position of the projector with respect to the image sensor.

In Step 104, a first synthetic image of the target, including an expected appearance of the optical markers, is rendered using a 3D model including known properties (e.g. geometry) of the optical markers, the estimate of the pose of the target with respect to the image sensor, and estimated values of intrinsic image sensor calibration parameters.

In Step 105, the estimate of the pose of the target relative to the image sensor and the estimated intrinsic image sensor calibration parameters are refined, by matching the captured image to the first synthetic image until convergence is reached. This is performed by inverse rendering (using an inverse renderer).

In Step 106, a second synthetic image of the target, including an expected pattern of the structured light, is rendered using a 3D model including the estimate of the pose of the target relative to the projector, the refined pose of the target relative to the image sensor and the refined intrinsic image sensor calibration parameters (obtained in step 105), known properties (e.g. geometry) of the expected pattern of structured light, and estimated values of intrinsic projector calibration parameters.

In step 107, the estimated pose of the target relative to the structured light projector and the estimated intrinsic projector calibration parameters are refined, by matching the captured image to the second synthetic rendered image until convergence is reached. This is performed by inverse rendering (using an inverse renderer).

The refined pose of the target relative to the image sensor and the refined intrinsic image sensor calibration parameters (obtained from step 105), together with the refined pose of the target relative to the projector and the refined intrinsic projector calibration parameters (obtained from step 107) represent final calibration data, which may then be stored by the processing unit 16.

During use of the structured illumination imaging device 10, the structured light projector 12 projects a pattern of structured light onto objects of interest in a scene, for example, a user's face for face recognition. The pattern is distorted by the (whole) object, and an image of the reflected, distorted pattern is captured by the image sensor 14. The captured image is corrected using the final calibration data generated in Step 5 (FIG. 2) or Steps 105 and 107 (FIG. 3), of calibration, and the corrected, captured image can be compared with the initial projected pattern to determine depth and surface information of the objects.

The present method can be used to calibrate structured light imaging devices for a range of applications. In some examples, structured light illumination calibrated according to the present method can be included in vehicles, mobile computing devices such as mobile phones, tablets, or wearables, game consoles, distance measuring devices, surveillance devices, and others.

It will be appreciated that several modifications may be made to the calibration method as described above. For example, one or more processing steps, e.g. the generation or storage of pattern data, or any of Steps 3 to 5 (FIG. 2) or Steps 103 to 107 (FIG. 3), may be performed outside of the processing unit 16, or outside of the structured light illumination device 10 altogether, for example, on a remote cloud server.

The structured light projector 12 of the calibrated device 10 may comprise any suitable type of light emitter, such as vertical-cavity surface-emitting lasers (VCSELs), side emitting semiconductor lasers, or laser diodes, and may emit light of any suitable wavelength, for example in the infra-red band. The image sensor 14 of the calibrated device 10 is also not particularly limited, and may comprise, for example, a complementary metal oxide semiconductor (CMOS) detector. Both the structured light projector 12 and the image sensor 14 may comprise additional optical elements such as band-pass filters, lenses, masks, or other refractive/diffractive optics, which contribute to the respective intrinsic parameters of the projector 12 and sensor 14 in the calibration data.

1. A method of calibrating a structured light imaging device comprising an image sensor and a structured light projector, the method comprises:
(a) projecting, by the structured light projector, a pattern of structured light onto a target, the target comprising a plurality of optical markers;
(b) capturing, by the image sensor, an image of the pattern on the target;
(c) determining, using (i) predetermined data specifying properties of the optical markers and (ii) the appearance of the markers in the captured image, a pose of the device relative to the target;
(d) rendering an image of the target and the pattern using the pose of the device and initial calibration data using a 3D model of the observed calibration scene; and
(e) iteratively refining said rendered image until a substantial convergence is achieved between the rendered image and the captured image by adjusting the calibration data.

2. The method of claim 1, wherein the calibration data comprises intrinsic parameters for the image sensor and the light projector, distortion coefficients, and extrinsic parameters.

3. The method of claim 1, wherein step (e) comprises applying a gradient descent algorithm to minimize a cost function comprising a 3D model of the captured scene to refine the calibration data.

4. A method of using a structured light imaging device comprising an image sensor and a structured light projector, the method comprising:
capturing, by the image sensor, an image; and
correcting said image using the adjusted calibration data according to claim 1.

5. A structured light imaging device comprising an image sensor and a structured light projector, and a memory storing adjusted calibration data generated using the method of claim 1.

6. A method of calibrating a structured light imaging device comprising an image sensor and a structured light projector, the method comprising:
(a) projecting, by the structured light projector, a pattern of structured light onto a target, the target comprising a plurality of optical markers;
(b) capturing, by the image sensor, an image of the pattern on the target;
(c) determining, using (i) predetermined data specifying properties of the optical markers and (ii) the appearance of the markers in the captured image, an estimated pose of the target relative to the image sensor and an estimated pose of the target relative to the structured light projector;
(d) rendering a first synthetic image of the target including an expected appearance of the optical markers, using a 3D model including known properties of the optical markers, the estimated pose of the target relative to the image sensor, and estimated values of intrinsic image sensor calibration parameters;
(e) refining, by inverse rendering, the estimated pose of the target relative to the image sensor and the estimated intrinsic image sensor calibration parameters, by matching the captured image to the first synthetic image until substantial convergence is reached;
(f) rendering a second synthetic image of the target including an expected pattern of the structured light, using a 3D model including known properties of the pattern of structured light, the estimated pose of the target relative to the structured light projector, the refined pose of the target relative to the image sensor, the refined intrinsic image sensor calibration parameters, and estimated values of intrinsic projector calibration parameters; and
(g) refining, by inverse rendering, the estimated pose of the target relative to the structured light projector and the estimated intrinsic projector calibration parameters, by matching the captured image to the second synthetic rendered image until substantial convergence is reached.
